(19) United States
(12) Patent Application Publication
(10) Pub. No.: US 2007/0037915 A1
(43) Pub. Date: Feb. 15, 2007

(54) Rubber composition for pneumatic tire and pneumatic tire

(75) Inventor: Yuuki Masumoto, Osaka-shi (JP)

Correspondence Address: JORDAN AND HAMBURG LLP, 122 EAST 42ND STREET, SUITE 4000, NEW YORK, NY, 10168, US

(73) Assignee: Toyo Tire & Rubber Co., Ltd., Osaka-shi (JP)

(21) Appl. No.: 11/473,253

(22) Filed: Jun. 22, 2006

(30) Foreign Application Priority Data
Aug. 9, 2005 (JP) 2005-231369

(51) Int. Cl. B60C 1/00

(52) U.S. Cl. 524/492; 524/261; 524/575

(57) ABSTRACT

A rubber composition for use in pneumatic tires in which a silica having BET specific surface area=190 to 300 m²/g and a CTAB specific surface area=140 to 300 m²/g is blended by more than 100 parts by weight and 200 parts by weight or less based on 100 parts by weight of a rubber ingredient containing 50% by weight or more of a styrene-butadiene copolymer rubber having a glass transition point≧−40° C., a styrene content≧30% by weight, and a weight average molecular weight≧800000, and a silane coupling agent of the following formula (1) is blended by from 2 to 25 parts by weight based on 100 parts by weight of the silica:
(CₙH₂ₙ₊₁O)₃Si—CₘH₂ₘ—S—CO—CₖH₂ₖ₊₁ (1) in which n is an integer of 1 to 3, m is an integer of 1 to 5, and k is an integer of 5 to 9.

### CROSS-REFERENCE TO RELATED APPLICATIONS

This application is based upon and claims the benefit of priority from the prior Japanese Patent Application No. 2005-231369, filed on Aug. 9, 2005; the entire contents of which are incorporated herein by reference.

### BACKGROUND OF THE INVENTION

1. Field of the Invention

The present invention relates to a rubber composition blended with silica for use in pneumatic tires and a pneumatic tire using the rubber composition.

2. Description of the Related Art

In pneumatic tires, particularly, high performance sports car tires, it is demanded for improving the gripping performance (including braking performance) on a wet road surface and handling stability, as well as a gripping performance (including braking performance) and handling stability on dry road surface simultaneously.

Generally, for improving the gripping performance on the wet road surface and the dry road surface, a method of increasing the blending amount of a filler and an oil has been used. In this case, however, a heat generation property is lowered to worsen the handling stability on the dry road surface, and lowering of the wear resistance, and worsening of the processability due to increase in the viscosity are observed. Further, while the use of a polymer having high glass transition point as a rubber ingredient may also be considered, this may lower the heat generation property or wear resistance, and worsen the handling stability on the dry road surface due to the worsening of the temperature dependence.

Further, while silica is used generally for improving the gripping performance on the wet road surface, in a case where the amount of silica is increased in order to further improve the gripping performance, this gives rise to a problem of worsening the processability due to increase in the viscosity. Further, as a method of improving the gripping performance on the wet road surface, it may be considered to increase the amount of the oil thereby lowering the rubber hardness, this may worsen the handling stability on the dry road surface.

On the other hand, as a method of improving the handling stability on the dry road surface, it may be considered to increase the rubber hardness by the increase in the amount of the filler, decrease in the amount of the oil, addition of a hardening agent, etc., this may worsen the gripping performance on the wet road surface.

As described above, it has been difficult to simultaneously improve the gripping performance and the handling stability on the wet road surface and the gripping performance and the handling stability on the dry road surface, and such demands have not yet been satisfied sufficiently at present.

In a silica-blended rubber composition for use in tires, it has been proposed to use a silane coupling agent in which mercapto groups are substituted as a coupling agent for bonding silica and a diene rubber (U.S. Pat. No. 4,519,430 (corresponding to JP-A No. 59-53206), JP-A Nos. 2000-239447 and 2000-344949). However, the blending amount of the silica in them is within a range of the general blending amount used so far and while use of styrene-butadiene rubber as the diene rubber has been disclosed in them, they do not disclose the combination of a styrene-butadiene rubber, silica and a protected mercapto silane which is feature inherent to the present invention.

Further, WO99/09036 proposes a novel protected mercapto silane as a silane coupling agent used together with silica for suppressing non-allowable increase in the viscosity during processing and improving early curing (scorching)

### SUMMARY OF THE INVENTION

The present invention has been made in view of the foregoings and it intends to provide a rubber composition for use in pneumatic tires, and capable of improving the gripping performance and the handling stability on the wet road surface and the gripping performance and the handling stability on the dry road surface simultaneously, as well as a pneumatic tire using the rubber composition.

The present inventor has found that incorporation and dispersibility of silica in a rubber ingredient during mixing can be improved by using a specified styrene-butadiene rubber of a relatively high glass transition point as a rubber ingredient and using a protected mercapto silane as a silane coupling agent in a blend in which silica of a relatively small grain size is filled in an amount more than that used customarily, thereby capable of improving the gripping performance and the handling stability on the wet road surface and the gripping performance and the handling stability on the dry road surface simultaneously and has achieved the invention.

That is, in a rubber composition for use in pneumatic tires according to the invention, a silica having a BET specific surface area of from 190 to 300 m²/g and a CTAB specific surface area of from 140 to 300 m²/g is blended by more than 100 parts by weight and 200 parts by weight or less based on 100 parts by weight of a rubber ingredient comprising a copolymer rubber obtained by copolymerization of 1,3-butadiene and styrene using an organic lithium compound as an initiator, having a glass transition point of −40° C. or higher, a styrene content of 30% by weight or more, and a weight average molecular weight of 800,000 or more, alone or a blend of 50% by weight or more of the copolymer rubber and 50% by weight or less of other diene rubber, and a silane coupling agent represented by the following general formula (1) is blended by from 2 to 25 parts by weight based on 100 parts by weight of the silica:
(CₙH₂ₙ₊₁O)₃Si—CₘH₂ₘ—S—CO—CₖH₂ₖ₊₁ (1)
in which n is an integer of 1 to 3, m is an integer of 1 to 5, and k is an integer of 5 to 9.

The pneumatic tire according to an invention has a tread comprising the rubber composition for use in the pneumatic tires described above.

According to the invention, since the styrene-butadiene rubber of high glass transition point is used for the rubber ingredient, and the protected mercapto silane represented by the formula (1) described above is used as the silane coupling agent together with silica of small grain size, in corporation of silica into the rubber ingredient during mixing can be improved and the dispersibility of silica of small grain size with high cohesion can be improved. In addition, blending of such silica of small grain size in an amount more than that used customarily can improve, in combination with the use of the specified styrene-butadiene rubber and the silane coupling agent, the gripping performance and the handling stability on the wet road surface and the gripping performance and the handling stability on the dry road surface simultaneously.

### DETAILED DESCRIPTION OF THE INVENTION

Hereinafter, matters relevant to the practice of the present invention are to be described specifically.

The copolymer rubber used as the rubber ingredient in the rubber composition of the invention is a styrene-butadiene rubber (SBR) obtained by copolymerization of 1,3-butadiene and styrene using an organic lithium compound as an initiator. Such copolymer rubber can be manufactured by using a known solution polymerization method using an inert organic solvent such as pentane, hexane, heptane, benzene, toluene, and diethyl ether. The organic lithium compound includes alkyl lithium such as n-butyl lithium, alkylene dilithium such as 1,4-dilithium butane, and phenyl lithium. The copolymer rubber may be treated at the terminal ends of the copolymer chain by tin, silicon, or an alkoxysilane type coupling agent, and terminal ends or the main chain thereof may be modified with a functional group having an interaction or chemical reactivity with the silanol group of silica (for example, hydroxyl group or amino group).

As the copolymer rubber, those having the glass transition point (Tg) of −40° C. or higher are used. By the use of the copolymer rubber having such high glass transition point, the gripping performance on the wet road surface and the dry road surface can be improved. While the upper limit of the glass transition point is not particularly restricted, it is usually −10° C. or lower. The glass transition point is a value obtained by increasing the temperature of a test specimen from a room temperature at a rate of 20° C./min and measuring the amount of heat generation by a differential scanning calorimeter.

Further, as the copolymer rubber, those having a styrene content of 30% by weight or more are used. In a case where the styrene content is less than 30% by weight, sufficient gripping performance both on the wet road surface and the dry road surface can not be obtained easily. While the upper limit of the styrene content is not particularly restricted, it is preferably 50% by weight or less.

Further, for the copolymer rubber described above, those having a weight average molecular weight (Mw) of 800000 or more are used. By using the copolymer rubber of such high molecular weight, it is possible to increase the rigidity to improve the gripping performance and the handling stability on the dry road surface. While the upper limit of the weight average molecular weight is not particularly restricted, it is usually 1600000 or less. The weight average molecular weight is a value measured by gel permeation chromatography (GPC) using tetrahydrofuran (THF) as a developing solvent.

The rubber ingredient in the rubber composition of the invention comprises the copolymer rubber described above alone, or a blend rubber of 50% by weight or more of the copolymer rubber and 50% by weight or less of other diene rubber. In a case where the ratio of the copolymer rubber is less than 50% by weight, the effect of the invention described above can not be provided sufficiently. The amount of the copolymer rubber is more preferably 70% by weight or more. Other diene rubber is not particularly restricted but includes natural rubbers, as well as synthetic diene rubbers such as isoprene rubber, butadiene rubber, styrene-isoprene-copolymer rubber, butadiene-isoprene copolymer rubber, styrene-isoprene-butadiene copolymer rubber and nitrile rubber. They may be used each alone or two or more of then may be used in combination. Among them, natural rubber and the butadiene rubber are more preferred.

Silica (hydrous silicic acid) used in the rubber composition of the invention is silica of small grain size having such colloidal characteristic as: 190≦BET specific surface area (nitrogen adsorption specific surface area)≦300 m²/g, and 140≦CTAB specific surface area (cetyltrimethyl ammonium bromide adsorption specific surface area)≦300 m²/g. In a case where the BET specific surface area and CTAB specific surface area are smaller than those in the range described above, the grain size of silica increase to deteriorate the gripping performance on the wet road surface and on the dry road surface. A preferred range of the BET specific surface area is 230 m²/g for the lower limit and 280 m²/g for the upper limit. Further, a more preferred range of the CTAB specific surface area is 150 m²/g for the lower limit and 250 m²/g and, more preferably, 210 m²/g for the upper limit. In the invention, the BET specific surface area is a value measured by the BET method according to ASTM D3037, and CTAB specific surface area is a value measured according to ASTM D3765.

The silica is blended by more than 100 parts by weight and not more than 200 parts by weight based on 100 parts by weight of the rubber ingredient. As described above, by blending the silica of small grain size in an amount remarkably increased compared with the general blending amount of silica so far, together with the use of the specified rubber ingredient and the silane coupling agent, it is possible to improve the gripping performance and the handling stability on the wet road surface and the dry road surface simultaneously. The silica is preferably blended by 125 parts by weight or more, for further improving the effect described above. Further, the upper limit for the blending amount is preferably 150 parts by weight or less with a view point of the working property in the processing of the rubber.

In the rubber composition of the invention, carbon black may also be blended together with the silica and the carbon black is blended by from 0 to 100 parts by weight and, more preferably, from 5 to 30 parts by weight based on 100 parts by weight of the rubber ingredient. Further, the silica and the carbon black are blended at a ratio of silica/carbon black=1.2/1 to 1/0, more preferably, 5/1 to 20/1 by weight ratio.

The silane coupling agent used for the rubber composition of the invention is a protected mercapto silane represented by the general formula (1). The protected mercapto silane can be manufactured according to the method described in WO99/09036. The protected mercapto, silane is blended by from 2 to 25 parts by weight based on 100 parts by weight of the silica in order to sufficiently provide the effect of the invention. Also the silane coupling agent may be previously treated to the silica and the treated silica may be blended by admixing to the rubber ingredient described above.

In the rubber composition of the invention, various additives used generally in the rubber composition for use in tires such as anti-aging agent, zinc oxide, stearic acid, softening agent, vulcanizer, and vulcanization accelerator can be blended in addition to the ingredients described above. As the method of preparing the rubber composition, it is preferred for providing the effect of the invention described above to mix the rubber ingredient and the silica (also optionally containing carbon black) and the silane coupling agent at 150 to 180° C. by using a known mixer.

In the rubber composition described above, since the specified styrene-butadiene rubber having a high glass transition point is used as the rubber ingredient and the protected mercapto silane is used as the silane coupling agent together with the silica of small grain size, it is possible to improve the incorporation of the silica in the rubber ingredient during mixing and improve the dispersibility of the small grain size silica having high cohesion. Accordingly, working property in rubber processing is excellent. In addition, since the silica of small grain size is used in an amount more than that in the existent case in the inherent combination described above, the gripping performance and the handling stability on the wet road surface as well as the gripping performance and the handling stability on the dry road surface can be improved. Accordingly, this can be used suitably, in particular, as a tread rubber for high performance sports car tires (for example, tire at an aspect ratio of 60% or less).

### EXAMPLES

Examples of the present invention are shown below but the invention is not restricted to such examples.

### Examples 1 to 6 and Comparative Examples 1 to 6

A rubber composition was prepared by using a Banbury mixer in accordance with the blend shown in the following Table 1. In this case, the mixing temperature of the rubber composition was set to 160° C. Details for each of the ingredients in Table 1 are as shown below.

SBR1: “TUFDENE E50”, manufactured by Asahi Kasei Co. (oil extended rubber: solution polymerized SBR obtained by using an organic lithium compound as an initiator, styrene content=36 wt %, glass transition point: Tg=−30° C., weight average molecular weight Mw=about 900000, containing 37.5 parts by weight of oil based on 100 parts by weight of rubber polymer)

SBR2: “SBR1502” manufactured by JSR Co. (emulsion polymerized SBR: styrene content=24 wt %, glass transition point Tg=−66° C., weight average molecular weight Mw=about 600000)

NR: Natural rubber RSS#3

Silica 1: “Z215GR” manufactured by Rhodia Co. (BET specific surface area=250 m²/g, CTAB specific surface area=160 m²/g)

Silica 2: Silica having BET specific surface area=240 m²/g, CTAB specific surface area=190 m²/g, prepared by the following method was used. That is, (1) to a reaction vessel filled with a silicate at a temperature within a range from 70 to 85° C., a mineral acid in an amount corresponding to 20 to 50% of a concentrated sulfuric acid required for neutralizing the entire amount of the silicate was added within 20 min, (2) the reaction mixture obtained in (1) above was heated to a temperature of 90 to 100° C. and a concentrated sulfuric acid in an amount corresponding to 80 to 50% of the entire amount of the concentrated sulfuric acid was added portionwise being divided for at least four times while keeping the temperature till pH of the reaction mixture reached a range of 7 to 10 and aged for 10 to 40 min after the addition of each concentrated sulfuric acid, and (3) the reaction mixture was aged for 30 to 120 min while keeping the temperature at 90 to 100° C., the reaction was completed by adding a mineral acid to render the same acidic to pH 5 or less, and the obtained precipitates (slurry) were thoroughly filtered, washed with water and dried to manufacture a silica. Since the BET specific surface area of the finally obtained silica was increased by increasing the amount of the concentrated sulfuric acid used for the neutralizing reaction in (1) above within a range from 20 to 50% of the entire amount of concentrated sulfuric acid and lowering the silica concentration in the reaction mixture within a range from 50 to 80 g/L, a silica having the BET specific surface area and CTAB specific surface area described above was obtained by controlling them.

Silica 3: “Ultrasil7000GR” manufactured by Degussa Co. (BET specific surface area=170 m²/g, CTAB specific surface area=160 m²/g)

Carbon black: ISAF, “DIABLACK N234”, manufactured by Mitsubishi Chemical Co.

Protected mercapto silane: coupling agent represented by the formula (1) above (n=2, m=3, k=7), “NXT” manufactured by GE Silicones Co.

General-purpose coupling agent: Bis-(3-triethoxy silylpropyl)disulfide, “Si-75” manufactured by Degussa Co.

Oil: aromatic process oil “JOMO process X 140” manufactured by Japan Energy Co.

Further, 2 parts by weight of wax (“Ozoace 0355”, manufactured by Nippon Seiro Co.), 2 parts by weight of an anti-aging agent (“Santoflex 6PPD”, manufactured by Flexisys Co.), 2 parts by weight of stearic acid (“Lunax S20”, manufactured by Kao Corp.), 2 parts of zinc oxide (“zinc oxide No. 1” manufactured by Mitsui Mining & Smelting Co., Ltd.), 1.5 parts by weight of a vulcanization accelerator CZ (“NOCCELER CZ-G”, manufactured by Ouchi Shinko Chemical Industry Co.), and 2 parts by weight of sulfur (“powdery sulfur 150 mesh”, manufactured by Hosoi Chemical Industry Co.) were blended as a common blend to 100 parts by weight of the rubber ingredient in each of the rubber compositions.

The processability was evaluated for each of the rubber compositions and pneumatic tires were manufactured by using them. Tires were manufactured by applying each of the rubber compositions to the cap tread of the testing radial tire of 215/45ZR17 having a tread of a cap/base structure and molding under vulcanization in accordance with a customary method. For each of the obtained tires, the gripping performance on the wet road surface and the dry road surface, the handling stability on the wet road surface and on the dry road surface were evaluated. Each of the evaluation methods is as described below.

Processability: The processability was evaluated by the Mooney viscosity measured by a Mooney viscometer manufactured by Shimazu Seisakusho. The testing method was according to JIS K6300 and indicated by an index based on the value of Comparative Example 1 being assumed as 100. As the value of the index is smaller this shows the viscosity is lower, that is, the processability is more favorable.

Gripping performance on the wet road surface (wet gripping performance): The pneumatic tires described above were attached by the number of four to a passenger car and the car was caused to run on a road surface with water being sprayed at a depth of 2 to 3 mm, and the friction coefficient was measured at a velocity of 100 km per hour and the wet gripping performance was evaluated. It is indicated by an index based on the value in Comparative Example 1 having assumed as 100, in which larger index shows more excellent gripping performance.

Gripping performance on the dry road surface (dry gripping performance): The pneumatic tires described above were attached by the number of four to a passenger car and the car was caused to run on a dry road surface, and the friction coefficient was measured at a velocity of 100 km per hour and the dry gripping performance was evaluated. It is indicated by an index based on the value in Comparative Example 1 being assumed as 100, in which larger index shows more excellent gripping performance.

Handling stability on the wet road surface (wet handling stability): the pneumatic tires were mounted by the number of four to a passenger car, a driver in charge for functional test ran along a test course with water being sprayed at a high speed while taking care of handling response, running stability, etc. to evaluate the steering stability. The result was shown, with reference to Comparative Example 1 as a control; “+2” for those which were more excellent than the control, “+1” for those which were somewhat more excellent, as “±0” for those which were equal with the control, as “−1” for those which were somewhat inferior and as “−2” for those which were inferior.

Handling stability on the dry road surface (dry handling stability): The pneumatic tires were mounted by the number of four to a passenger car, a driver in charge for functional test ran along a dry test course at a high speed while taking care of steering response, running stability, etc. to evaluate the handling stability. The result was shown, with reference to Comparative Example 1 as a control, as: “+2” for those which were more excellent than the control, “+1” for those somewhat more excellent, as “±0” for those which were equal with the control, as “−1” for those which were somewhat inferior, and as “−2” for those which were inferior.

| | | Comp | Comp | Comp | Comp | Comp | Comp | Exam- | Exam- | Exam- | Exam- | Exam- | Exam- |
|---|---|---|---|---|---|---|---|---|---|---|---|---|---|
| | | Example 1 | Example 2 | Example 3 | Example 4 | Example 5 | Example 6 | ple 1 | ple 2 | ple 3 | ple 4 | ple 5 | ple 6 |
| Blend | SBR1 | 137.5 | 137.5 | 137.5 | | 137.5 | 110 | 137.5 | 137.5 | 137.5 | 137.5 | 110 | 110 |
| (parts | SBR2 | | | | 100 | | | | | | | | |
| by | NR | | | | | | 20 | | | | | 20 | 20 |
| weight) | Silica 1 | 70 | 70 | 110 | 110 | | 70 | 110 | 130 | 150 | | 110 | 130 |
| | (small | | | | | | | | | | | | |
| | grain) | | | | | | | | | | | | |
| | Silica 2 | | | | | | | | | | 130 | | |
| | (small | | | | | | | | | | | | |
| | grain) | | | | | | | | | | | | |
| | Silica 3 | | | | | 110 | | | | | | | |
| | Carbon | 20 | 20 | 10 | 10 | 10 | 20 | 10 | 10 | 10 | 10 | 10 | 10 |
| | Black | | | | | | | | | | | | |
| | Protected | | 6 | | 9 | 9 | | 9 | 10 | 12 | 10 | 9 | 10 |
| | mercapto | | | | | | | | | | | | |
| | silane | | | | | | | | | | | | |
| | General- | 6 | | 9 | | | 6 | | | | | | |
| | purpose | | | | | | | | | | | | |
| | coupling | | | | | | | | | | | | |
| | agent | | | | | | | | | | | | |
| | Oil | 2.5 | 2.5 | 11 | 48.5 | 2.5 | 10 | 11 | 19.5 | 28 | 19.5 | 18.5 | 27 |

| | | | | | | | | | | | | |
|---|---|---|---|---|---|---|---|---|---|---|---|---|
| Processability | 100 | 79 | 130 | 84 | 85 | 98 | 89 | 100 | 113 | 104 | 86 | 96 |
| Wet gripping | 100 | 107 | 91 | 98 | 105 | 95 | 110 | 113 | 115 | 114 | 106 | 109 |
| performance | | | | | | | | | | | | |
| Dry gripping | 100 | 106 | 92 | 101 | 101 | 95 | 106 | 108 | 108 | 108 | 105 | 107 |
| performance | | | | | | | | | | | | |
| Wet handling | — | +1 | −1 | −1 | +1 | −1 | +2 | +2 | +2 | +2 | +1 | +2 |
| stability | | | | | | | | | | | | |
| Dry handling | — | 0 | 0 | −1 | 0 | 0 | +1 | +2 | +2 | +2 | +1 | +1 |
| stability | | | | | | | | | | | | |

As shown in Table 1, according to Examples 1 to 6 of the invention, the gripping performance and the handling stability on the wet road surface, and the gripping performance and the handling stability on the dry road surface were improved simultaneously and outstandingly while improving the working property in the rubber processing or at least suppressing the worsening of the working property as much as possible compared with Comparative Example 1 or Comparative Example 6. On the contrary, in Comparative Example 3 in which the amount of the silica was increased merely, not only the processability was impaired greatly but also the effect for improving the gripping performance and the handling stability was not recognized. Further, in Comparative Example 4 in which the rubber ingredient was out of the invention, although the processability was improved, the effect of improving the gripping performance and the handling stability could not be obtained. Further, in Comparative Example 2 in which the blending amount of the small grain size silica was small, although the gripping performance was improved, the effect of improving the handling stability was insufficient. Further, in Comparative Example 5 using the silica of large grain size, although the processability was excellent, the effect of improving the gripping performance and the handling stability was insufficient.

The rubber composition for use in pneumatic tires according to the invention can be utilized as a rubber constituting treads of various kinds of pneumatic tires and it is particularly suitable to high performance sports car tires.

What is claimed is:

1. A rubber composition for use in pneumatic tires comprising;
a rubber ingredient comprising at least one copolymer rubber obtained by copolymerization of 1,3-butadiene and styrene using an organic lithium compound as an initiator, having a glass transition point of −40° C. or higher, a styrene content of 30% by weight or more, and a weight average molecular weight of 800,000 or more, alone or a blend of 50% by weight or more of the copolymer rubber and 50% by weight or less of other diene rubber,
more than 100 parts by weight and not more than 200 parts by weight of silica based on 100 parts by weight of the rubber ingredient, said silica having a BET specific surface area of from 190 to 300 m²/g and a CTAB specific surface area of from 140 to 300 m²/g, and
from 2 to 25 parts by weight of a silane coupling agent based on 100 parts by weight of the silica, said silane coupling agent being represented by the following general formula (1):
(CₙH₂ₙ₊₁O)₃Si—CₘH₂ₘ—S—CO—CₖH₂ₖ₊₁ (1)
in which n is an integer of 1 to 3, m is an integer of 1 to 5, and k is an integer of 5 to 9.

2. A rubber composition for use in pneumatic tires according to claim 1, wherein the silica has a BET specific surface area of from 230 to 280 m²/g, and a CTAB specific surface area of from 150 to 250 m²/g.

3. A rubber composition for use in pneumatic tires according to claim 1, wherein the silica is blended by from 125 to 150 parts by weight based on 100 parts by weight of the rubber ingredient.

4. A rubber composition for use in pneumatic tires according to claim 1, further comprising 100 parts by weight or less of carbon black based on 100 parts by weight of the rubber ingredient.

5. A rubber composition for use in pneumatic tires according to claim 1, wherein the composition is obtained by mixing the rubber ingredient, the silica and the silane coupling agent at 150 to 180° C.

6. A pneumatic tire having a tread comprising the rubber composition according to claim 1.

7. A pneumatic tire according to claim 6 wherein an aspect ratio of the tire is 60% or less.
